(19) United States
(12) Patent Application Publication
(10) Pub. No.: US 2025/0326271 A1
(43) Pub. Date: Oct. 23, 2025

(54) VEHICLE AIR CONDITIONING SYSTEM AND METHOD FOR USING HUMIDITY CONTROLLING DEVICE

(71) Applicant: NGK INSULATORS, LTD., Nagoya-City (JP)

(72) Inventor: Takafumi HAMADA, Nagoya-Shi (JP)

(73) Assignee: NGK INSULATORS, LTD., Nagoya-City (JP)

(21) Appl. No.: 19/087,804

(22) Filed: Mar. 24, 2025

(30) Foreign Application Priority Data
Apr. 19, 2024 (JP) 2024-068576
Jan. 17, 2025 (JP) 2025-007109

(51) Int. Cl. B60H 1/00; B60H 3/02

(52) U.S. Cl. CPC B60H 1/00821; B60H 3/024

(57) ABSTRACT

A vehicle air conditioning system includes: an air conditioning duct through which air can flow; at least one humidity controlling device including: a honeycomb structure having an outer peripheral wall and partition walls provided on an inner side of the outer peripheral wall, the partition walls defining a plurality of cells, each of the cells extending from a first end face to a second end face; and a moisture absorbing layer provided on a surface of each of the partition walls, the humidity controlling device being provided in the air conditioning duct; and a control unit configured to control a flow velocity of the air flowing through the cells of the humidity controlling device. The control unit includes controlling the flow velocity of the air flowing in the humidity controlling device to 0.23 to 1.40 m/s in the moisture absorption process of the humidity controlling device.

### CROSS REFERENCE TO RELATED APPLICATIONS

This application claims the benefit of priority to Japanese Patent Application No 2024-068576 filed on Apr. 19, 2024 and Japanese Patent Application No 2025-007109 filed on Jan. 17, 2025 with the Japanese Patent Office, the entire contents of which are incorporated herein by reference in its entirety.

### FIELD OF THE INVENTION

The disclosure may relate to a vehicle air conditioning system and a method for using a humidity controlling device.

### BACKGROUND OF THE INVENTION

In various types of vehicles such as automobiles, there are increasing requirements for improvement of vehicle interior environment. Specific requirements include humidity control of the vehicle interior. The effective measure for such requirements includes ventilation, but the ventilation causes a large loss of heater energy in winter, leading to a decreased energy efficiency in winter. In particular, a battery electric vehicle (BEV) has a problem that its cruising range is significantly reduced due to its energy loss

As a method for solving the above problems, Patent Literature 1 proposes a heater element comprising: a honeycomb structure having an outer peripheral wall and partition walls disposed on an inner side of the outer peripheral wall, the partition walls defining a plurality of cells each extending from one end face to other end face to form a flow path, at least the partition walls having a material having a PTC (Positive Temperature Coefficient) property; and a pair of electrodes provided on certain positions of the honeycomb structure, wherein the heater element has a functional material-containing layer for adsorbing water vapor and the like on surfaces of the partition walls.

However, only the use of the heater element of Patent Literature 1 cannot lead to efficient adsorption of moisture (water vapor).

The disclosure was made to solve the problems as described above. An object of the disclosure is to provide a vehicle air conditioning system that can efficiently adsorb the moisture, and a method for using a humidity controlling device.

### PRIOR ART

### Patent Literature

[Patent Literature 1] WO 2023/074202 A1

### SUMMARY OF THE INVENTION

As results of intensive studies on vehicle air conditioning systems including humidity controlling devices, the inventor has found that an amount of moisture absorbed can be improved by controlling a flow velocity of air flowing in a humidity controlling device, and has completed one or more embodiments of the disclosure. In other words, the embodiments are exemplified as follows:

[1]

A vehicle air conditioning system, which may include: an air conditioning duct through which air can flow;
at least one humidity controlling device including: a honeycomb structure having an outer peripheral wall and partition walls provided on an inner side of the outer peripheral wall, the partition walls defining a plurality of cells, each of the cells extending from a first end face to a second end face of the honeycomb structure to form a flow path for the air; and a moisture absorbing layer provided on a surface of each of the partition walls, the humidity controlling device being provided in the air conditioning duct; and
a control unit configured to control a flow velocity of the air flowing through the cells of the humidity controlling device,
wherein the control unit may include controlling the flow velocity of the air flowing in the humidity controlling device to 0.23 to 1.40 m/s in a moisture absorption process of the humidity controlling device.
   [2]

The vehicle air conditioning system according to [1], wherein the control unit may include controlling the flow velocity of the air flowing in the humidity controlling device to 0.24 to 1.30 m/s in the moisture absorption process of the humidity controlling device.

[3]

The vehicle air conditioning system according to [1], wherein the control unit may include controlling the flow velocity of the air flowing in the humidity controlling device to 0.25 to 1.20 m/s in the moisture absorption process of the humidity controlling device.

[4]

The vehicle air conditioning system according to [1], wherein the control unit may include controlling the flow velocity of the air flowing in the humidity controlling device to 0.26 to 1.10 m/s in the moisture absorption process of the humidity controlling device.

[5]

The vehicle air conditioning system according to any one of [1] to [4], wherein the control unit may include performing the moisture absorption process of the humidity controlling device for 0.16 to 6 minutes.

[6]

The vehicle air conditioning system according to any one of [1] to [5], wherein the control unit may include controlling the flow velocity of the air flowing in the humidity controlling device to 0.06 to 0.30 m/s in a regeneration process of the humidity controlling device.

[7]

The vehicle air conditioning system according to [6], wherein the control unit may include controlling the flow velocity of the air flowing in the humidity controlling device to 0.08 to 0.20 m/s in the regeneration process of the humidity controlling device.

[8]

The vehicle air conditioning system according to [6] or [7], wherein the control unit may include performing the regeneration process of the humidity controlling device for 0.16 to 4 minutes.

[9]

A method for using a humidity controlling device, the humidity controlling device including: a honeycomb structure having an outer peripheral wall and partition walls provided on an inner side of the outer peripheral wall, the partition walls defining a plurality of cells, each of the cells extending from a first end face to a second end face of the honeycomb structure to form a flow path for air; and a moisture absorbing layer provided on a surface of each of the partition walls, the humidity controlling device being provided in the air conditioning duct, wherein the method includes controlling a flow velocity of the air flowing in the humidity controlling device to 0.23 to 1.40 m/s during a moisture absorption process of the humidity controlling device.

[10]

The method for using the humidity controlling device according to [9], wherein the method may include controlling the flow velocity of the air flowing in the humidity controlling device to 0.24 to 1.30 m/s during the moisture absorption process of the humidity controlling device.

[11]

The method for using the humidity controlling device according to [9], wherein the method may include controlling the flow velocity of the air flowing in the humidity controlling device to 0.25 to 1.20 m/s during the moisture absorption process of the humidity controlling device.

[12]

The method for using the humidity controlling device according to [9], wherein the method may include controlling the flow velocity of the air flowing in the humidity controlling device to 0.26 to 1.10 m/s during the moisture absorption process of the humidity controlling device.

[13]

The method for using the humidity controlling device according to any one of [9] to [12], wherein the method may include performing the moisture absorption process of the humidity controlling device for 0.16 to 6 minutes.

[14]

The method for using a humidity controlling device according to any one of [9] to [13], wherein the method may include controlling the flow velocity of the air flowing in the humidity controlling device to 0.06 to 0.30 m/s during a regeneration process of the humidity controlling device.

[15]

The method for using the humidity controlling device according to [14], wherein the method may include controlling the flow velocity of the air flowing in the humidity controlling device to 0.08 to 0.20 m/s during the regeneration process of the humidity controlling device.

[16]

The method for using the humidity controlling device according to or [15], wherein the method may include performing the regeneration process of the humidity controlling device for 0.16 to 4 minutes.

### BRIEF DESCRIPTION OF THE DRAWINGS

FIG. 1 is an overall schematic configuration view of a vehicle air conditioning system according to an embodiment;

FIG. 2A is a schematic view of a cross section of a humidity controlling device used in a vehicle air conditioning system according to an embodiment, which is parallel to a flow path direction; and

FIG. 2B is a schematic cross-sectional view of the humidity controlling device taken along the line a-a′ in FIG. 2A.

### DETAILED DESCRIPTION OF THE INVENTION

A vehicle air conditioning system according to the invention includes: an air conditioning duct through which air can flow; a humidity controlling device including: a honeycomb structure having an outer peripheral wall and partition walls provided on an inner side of the outer peripheral wall, the partition walls defining a plurality of cells, each of the cells extending from a first end face to a second end face of the honeycomb structure to form a flow path for the air; and an adsorbing layer provided on a surface of each of the partition walls, the humidity controlling device being provided in the air conditioning duct; and a control unit configured to control a flow velocity of the air flowing through the cells of the humidity controlling device. The control unit includes controlling the flow velocity of the air flowing in the humidity controlling device to 0.23 to 1.40 m/seconds in the moisture absorption process of the humidity controlling device. According to such a configuration, the vehicle air conditioning system according to the invention can effectively adsorb the moisture in the moisture adsorbing layer of the humidity controlling device. Therefore, the moisture adsorption function in the moisture absorbing layer of the humidity controlling device can be improved to the maximum.

A method for using a humidity controlling device according to the invention, which includes: a honeycomb structure having an outer peripheral wall and partition walls provided on an inner side of the outer peripheral wall, the partition walls defining a plurality of cells, each of the cells extending from a first end face to a second end face of the honeycomb structure to form a flow path for the air; and an adsorbing layer provided on a surface of each of the partition walls, the humidity controlling device being provided in the air conditioning duct, includes controlling a flow velocity of the air flowing in the humidity controlling device to 0.23 to 1.40 m/s during a moisture absorption process of the humidity controlling device. With such a configuration, the method for using the humidity controlling device according to the invention can efficiently adsorb the moisture in the moisture absorbing layer of the humidity controlling device. Therefore, the moisture adsorption function in the moisture adsorbing layer of the humidity controlling device can be improved to the maximum.

Hereinafter, embodiments of the invention will be specifically described with reference to the drawings. It should be understood that the invention is not limited to the following embodiments, and those which have appropriately added changes, improvements and the like to the following embodiments based on knowledge of a person skilled in the art without departing from the spirit of the invention fall within the scope of the invention.

### <Vehicle Air Conditioning System>

The vehicle air conditioning system according to an embodiment can be suitably utilized for various vehicles such as automobiles. The vehicle includes, but not limited to, automobiles and electric rail cars. Non-limiting examples of the automobile include a gasoline vehicle, a diesel vehicle, a gas fuel vehicle using CNG (compressed natural gas) or LNG (liquefied natural gas), a fuel cell vehicle, an electric vehicle, and a plug-in hybrid vehicle. In particular, the vehicle air conditioning system according to an embodiment can be suitably used for a vehicle that has no internal combustion engine such as electric vehicles and electric rail cars.

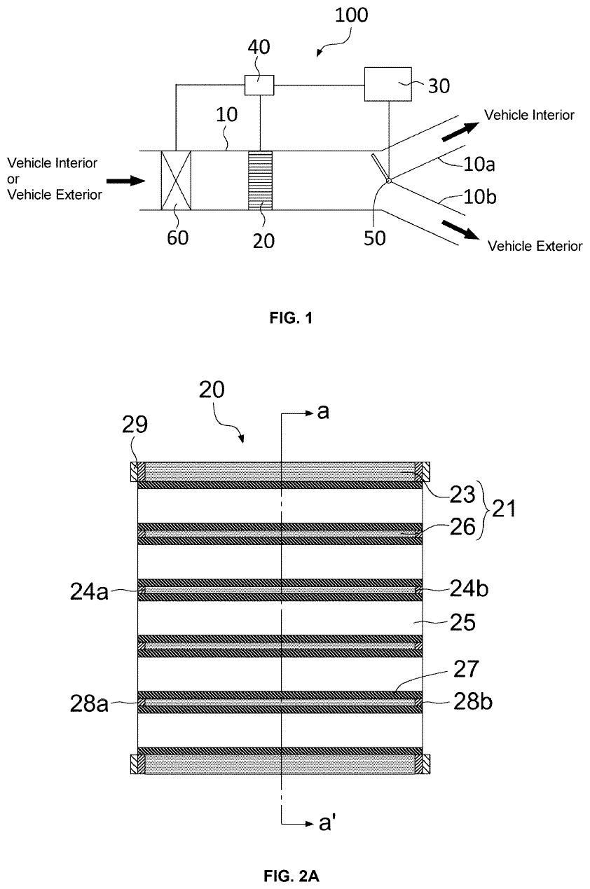

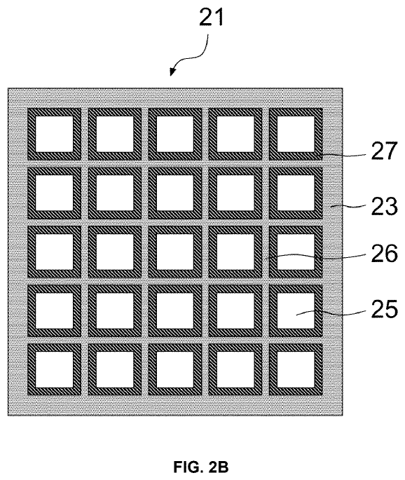

FIG. 1 is an overall schematic configuration view of a vehicle air conditioning system according to an embodiment. FIG. 2A is a schematic view of a cross section of a humidity controlling device used in a vehicle air conditioning system according to an embodiment, which is parallel to a flow path direction. FIG. 2B is a schematic cross-sectional view of the humidity controlling device in FIG. 2A taken along the line a-a′.

As shown in FIG. 1, a vehicle air conditioning system 100 according to an embodiment includes: an air conditioning duct 10; a humidity controlling device 20; and a control unit 30. Further, the vehicle air conditioning system 100 can further include: a power source 40; a valve 50; and a ventilation fan 60.

The air conditioning duct 10 can allow air from the vehicle interior or the vehicle exterior to flow therethrough. The air conditioning duct 10 can have, on a downstream side of the humidity controlling device 20, a first flow path 10a that allows the air to flow into the vehicle interior, and a second flow path 10b that allows the air to be discharged to the vehicle exterior.

The humidity controlling device 20 is provided in the air conditioning duct. The number of humidity controlling devices 20 provided in the air conditioning duct 10 may be one or more than one. When more than one humidity controlling devices 20 are provided, they may be arranged in parallel to or in series with the flow of the air flowing through the air conditioning duct 10.

As shown in FIGS. 2A and 2B, the humidity controlling device 20 includes: a honeycomb structure 21 having an outer peripheral wall 23 and partition walls 26 provided on an inner side of the outer peripheral wall 23, the partition walls 26 defining a plurality of cells 25 each extending from a first end face 24a to a second end face 24b of the honeycomb structure 21 to form a flow path for air; and a moisture absorbing layer 27 provided on a surface of each of the partition wall 26. The honeycomb structure 21 can further include: a pair of electrodes 28a, 28b; and terminals 29 connected to the pair of electrodes 28a, 28b.

The control unit 30 can control the flow velocity of the air flowing through the cells 25 of the humidity controlling device 20. Specifically, the control unit 30 controls the flow rate of the air by adjusting the rotation speed of the ventilation fan 60 electrically connected to the control unit 30. The control unit 30 is also electrically connected to a power source 40, a valve 50, and the like, and it can control these members.

In the vehicle air conditioning system 100 having the above structure, the air from the vehicle interior or vehicle exterior flows in the humidity controlling device 20 through the air conditioning duct 10, in the moisture absorption process and the regeneration process of the humidity controlling device 20. In the moisture absorption process of the humidity controlling device 20, the moisture in the air is trapped (adsorbed) by a moisture absorbing layer 27 of the humidity controlling device 20, and the air with reduced moisture flows in the vehicle interior through first flow path 10a. On the other hand, in the regeneration process of the humidity controlling device 20, the moisture trapped in the moisture absorbing layer 27 are separated as the honeycomb structure 21 of the humidity controlling device 20 is heated, and the air containing the moisture flows out to the vehicle exterior through the second flow path 10b. The moisture absorption process and the regeneration process of the humidity controlling device 20 are repeatedly performed until the humidity in the vehicle interior is in the appropriate range.

In the moisture absorption process of the humidity controlling device 20, the control unit 30 includes controlling the flow velocity of the air flowing in the humidity controlling device 20 to 0.23 to 1.40 m/s, preferably 0.24 to 1.30 m/s, more preferably 0.25 to 1.20 m/s, and even more preferably 0.26 to 1.10 m/s. With such control of the flow velocity, the moisture can be efficiently adsorbed in the moisture absorbing layer 27 of the humidity controlling device 20 while feeding dry air that is difficult to fog up windows for a long period of time. On the other hand, if the flow velocity of the air is less than 0.23 m/s, the amount of moisture adsorbed decreases, so that the moisture absorption process of the humidity conditioning device 20 needs to be performed for a longer period of time, and it is also difficult to feed the dry air that is difficult to fog up the windows. If the flow velocity of the air exceeds 1.40 m/s, the amount of moisture adsorbed becomes excessive and is early saturated, so that the time to feed the dry air that is difficult to fog up the windows will be shortened. Furthermore, the size of the ventilation fan 60 needs to be increased in order to increase the flow velocity of the air, or the noise level increases due to the increased rotation speed of the ventilation fan 60, or the requirements for the surrounding components such as the air conditioning duct 10 become more demanding due to the increased pressure loss.

The duration time for the moisture absorption process of the humidity controlling device 20 is not particularly limited, but it may preferably be 0.16 to 6 minutes, more preferably 0.33 to 5 minutes, and even more preferably 0.5 to 4 minutes. By limiting the duration time for the moisture adsorption process to that range, it is easier to ensure the amount of moisture adsorbed while limiting the waste of the moisture adsorption process due to the saturation of the amount of the moisture adsorbed. On the other hand, if the moisture absorption process of the humidity controlling device 20 is for less than 0.16 minutes, it is difficult to ensure the amount of the moisture adsorbed. If the duration time for the moisture absorption process of the humidity controlling device 20 exceeds 6 minutes, the amount of the moisture adsorbed is easily saturated.

In the regeneration process of the humidity conditioning device 20, the control unit 30 preferably includes controlling the flow velocity of the air flowing in the humidity conditioning device 20 to 0.06 to 0.30 m/s. According to such control of the flow velocity, it is possible to separate the moisture adsorbed in the moisture absorbing layer 27 of the humidity controlling device efficiently. According to such control of the flow velocity, the need to adjust the flow velocity in two steps or the like is eliminated, thereby facilitating the control of the regeneration process. From the viewpoint of stably ensuring these effects, it is more preferable that the control unit 30 includes controlling the flow velocity of the air to 0.08 to 0.20 m/s. On the other hand, if the flow velocity of the air exceeds 0.30 m/s, the humidity controlling device 20 is easily cooled by the circulating air, making it difficult for the moisture to be separated from the moisture absorbing layer 27. If the flow velocity of the air is less than 0.06 m/s, the contact with the circulating air decreases, so that the moisture is difficult to be separated from the moisture absorbing layer 27.

The duration time for the regeneration process of the humidity controlling device 20 is not particularly limited, but it may preferably be 0.16 to 4 minutes, more preferably 0.33 to 4 minutes, and even more preferably 0.5 to 3 minutes. By limiting the duration time for the regeneration process to that range, it is easier to ensure the amount of the moisture separated while limiting the waste of the regeneration process due to saturation of the amount of the moisture separated. On the other hand, if the regeneration process of the humidity controlling device 20 is for less than 0.16 minutes, it is difficult to ensure the amount of the moisture separated. If the regeneration process of the humidity controlling device 20 exceeds 4 minutes, the amount of the moisture separated is easily saturated. Each component of the vehicle air conditioning system 100 will be described below in detail.

### (1. Air Conditioning Duct 10)

The air conditioning duct 10 is a flow path through which air can flow. The upstream side of the air conditioning duct 10 is connected to the vehicle interior or an outside air introduction port. The air conditioning duct 10 allows the air from the vehicle interior or vehicle exterior to flow therein, and also allows the air that has passed through the humidity controlling device 20 to flow in the vehicle interior or flow out to the vehicle exterior. Therefore, on a downstream side of the humidity controlling device 20, the air conditioning duct 10 preferably branches into the first flow path 10a that allows the air to flow into the vehicle interior, and the second flow path 10b that allows the air to be discharged to the vehicle exterior.

The air conditioning duct 10 may include a valve 50 that can switch the flow of the air between the first flow path 10a and the second flow path 10b. The valve 50 is not particularly limited as long as it is electrically driven and has the function of switching the flow path, and a solenoid valve, an electric valve, and the like can be used. For example, the valve 50 includes an opening/closing door supported by a rotating shaft and an actuator such as a motor that rotates the rotating shaft. The actuator can be configured to be controllable by the control unit 30.

### (2. Humidity Controlling Device 20)

### (2-1. Honeycomb Structure 21)

The shape of the honeycomb structure 21 is not particularly limited. For example, an outer shape of a cross section of the honeycomb structure 21 orthogonal to the flow path direction (extending direction of the cells 25) can be polygonal such as quadrangular (rectangular, square), pentagonal, hexagonal, heptagonal, and octagonal, circular, oval (egg-shaped, elongated circular, elliptical, rounded rectangular, etc.), or the like. The end faces (first end face 24a and second end face 24b) have the same shape as the cross section. Also, when the cross section and the end faces are polygonal, the corners may be chamfered.

The shape of each cell 25 is not particularly limited, but it may be polygonal such as quadrangular, pentagonal, hexagonal, heptagonal, and octagonal, circular, or oval in the cross section of the honeycomb structure 21 orthogonal to the flow path direction. These shapes may be alone or in combination of two or more. Moreover, among these shapes, the quadrangle or the hexagon is preferable. By providing the cells 25 having such a shape, it is possible to reduce the pressure loss when the air flows.

The honeycomb structure 21 may be a honeycomb joined body that includes a plurality of honeycomb segments and joining layers that join outer peripheral side surfaces of the plurality of honeycomb segments together. The use of the honeycomb joined body can increase the total cross-sectional area of the cells 25, which is important for ensuring the flow rate of air, while suppressing cracking.

It should be noted that the joining layer can be formed by using a joining material. The joining material is not particularly limited, but a ceramic material obtained by adding a solvent such as water to form a paste can be used. The joining material may contain a material having a PTC property, or may contain the same material as the outer peripheral wall 23 and the partition walls 26. In addition to the role of joining the honeycomb segments to each other, the joining material can also be used as an outer peripheral coating material after joining the honeycomb segments.

From the viewpoints of ensuring the strength of the honeycomb structure 21, reducing pressure loss when air passes through the cells 25, ensuring the amount of functional material supported, and ensuring the contact area with the air flowing inside the cells 25, it is desirable to suitably combine a thickness of the partition wall 26, a cell density, and a cell pitch (or an opening ratio of the cells 25).

As used herein, the cell density refers a value obtained by dividing a number of cells by an area of one end face (first end face 24a or second end face 24b) of the honeycomb structure 21 (the total area of the partition walls 26 and the cells 25 excluding the outer peripheral wall 23).

As used herein, the cell pitch refers to a value obtained by the following calculation. First, the area of one end face (first end face 24a or second end face 24b) of the honeycomb structure 21 (the total area of the partition walls 26 and the cells 25 excluding the outer peripheral wall 23) is divided by the number of the cells to calculate an area per a cell. A square root of the area per a cell is then calculated, and this is determined to be the cell pitch.

As used herein, the opening ratio of the cells 25 refers a value obtained by dividing the total area of the cells 25 defined by the partition walls 26 by the area of one end face (first end face 24a or second end face 24b) (the total area of the partition walls 26 and the cells 25 excluding the outer peripheral wall 23) in the cross section orthogonal to the flow path direction of the honeycomb structure 21. It should be noted that when calculating the opening ratio of the cells 25, the pair of electrodes 28a, 28b, and the moisture absorbing layer 27 are not taken into account.

In an embodiment that is advantageous from the viewpoint of supporting a sufficient amount of functional material, the thickness of the partition walls 26 is 0.300 mm or less, the cell density is 100 cells/cm² or less, and the cell pitch is 1.0 mm or more. In a preferred embodiment, the thickness of the partition walls 26 is 0.200 mm or less, the cell density is 70 cells/cm² or less, and the cell pitch is 1.2 mm or more. In a more preferred embodiment, the thickness of the partition walls 26 is 0.130 mm or less, the cell density is 65 cells/cm² or less, and the cell pitch is 1.3 mm or more.

From the viewpoints of ensuring the strength of the honeycomb structure 21 and maintaining lower electrical resistance, the lower limit of the thickness of the partition wall 26 is preferably 0.010 mm or more, more preferably 0.020 mm or more, and even more preferably 0.030 mm or more.

From the viewpoints of ensuring the strength of the honeycomb structure 21, maintaining lower electrical resistance, and increasing a surface area to facilitate reaction, adsorption, and separation, the lower limit of the cell density is 30 cells/cm² or more, and preferably 35 cells/cm² or more, and even more preferably 40 cells/cm² or more.

From the viewpoints of ensuring the strength of the honeycomb structure 21, maintaining lower electrical resistance and increasing a surface area to facilitate reaction, adsorption and separation, the upper limit of the cell pitch is 2.0 mm or less, more preferably 1.8 mm or less, and even more preferably 1.6 mm or less.

In an embodiment that is advantageous in terms of both reducing pressure loss and maintaining strength, the thickness of the partition walls 26 is 0.08 to 0.36 mm, the cell density is 2.54 to 140 cells/cm², and the opening ratio of the cells 25 is 0.70 or more. In a preferred embodiment, the thickness of the partition walls 26 is 0.09 to 0.35 mm, the cell density is 15 to 100 cells/cm², and the opening ratio of the cells 25 is 0.80 or more. In a more preferred embodiment, the thickness of the partition walls 26 is 0.14 to 0.30 mm, the cell density is 20 to 90 cells/cm², and the opening ratio of the cells 25 is 0.85 or more.

From the viewpoint of ensuring the strength of the honeycomb structure 21, the upper limit of the opening ratio of the cells 25 is preferably 0.94 or less, more preferably 0.92 or less, and even more preferably 0.90 or less.

Although the thickness of the outer peripheral wall 23 is not particularly limited, it is preferably determined based on the following considerations. First, from the viewpoint of reinforcing the honeycomb structure 21, the thickness of the outer peripheral wall 23 is preferably 0.05 mm or more, more preferably 0.06 mm or more, and even more preferably 0.08 mm or more. On the other hand, when the viewpoint of suppressing the initial current by increasing the electrical resistance and from the viewpoint of reducing pressure loss when air flows are considered, the thickness of the outer peripheral wall 23 is preferably 1.0 mm or less, more preferably 0.5 mm, even more preferably 0.4 mm or less, and still more preferably 0.3 mm or less.

As used herein, the thickness of the outer peripheral wall 23 refers to a length from a boundary between the outer peripheral wall 23 and the outermost cell 25 or the partition wall 26 to a side surface of the honeycomb structure 21 in a normal line direction of the side surface in the cross section orthogonal to the flow path direction.

The length of the honeycomb structure 21 in the flow path direction and the cross-sectional area orthogonal to the flow path direction may be adjusted according to the required size of the humidity controlling device 20, and are not particularly limited. For example, when used in a compact humidity controlling device 20 while ensuring a predetermined function, the honeycomb structure 21 can have a length of 2 to 20 mm in the flow path direction and a cross-sectional area of 10 cm² or more orthogonal to the flow path direction. Although the upper limit of the cross-sectional area orthogonal to the flow path direction is not particularly limited, it is, for example, 300 cm² or less.

The partition walls 26 forming the honeycomb structure 21 are preferably made of a material that can be heated by electric conduction, specifically made of a material having a PTC property. Further, the outer peripheral wall 23 may also be made of a material having a PTC property, as with the partition walls 26, as needed. By such a configuration, the moisture absorbing layer 27 can be directly heated by heat transfer from the heat-generating partition walls 26 (and optionally the outer peripheral wall 23). Further, the material having the PTC property has characteristics such that when the temperature increases to exceed the Curie point, the resistance value is sharply increased, making it difficult for electricity to flow. Therefore, when the temperature of the partition walls 26 (and the outer peripheral wall 23 if necessary) becomes high, the current flowing through them is limited, thereby suppressing excessive heat generation of the honeycomb structure 21. Therefore, it is possible to suppress thermal deterioration of the moisture absorbing layer 27 due to excessive heat generation.

From the viewpoint of obtaining appropriate heat generation, the lower limit of the volume resistivity at 25° C. of the material having the PTC property is preferably 0.5 Ω·cm or more, and more preferably 1 Ω·cm or more, and even more preferably 5 Ω·cm or more. From the viewpoint of generating heat with a low driving voltage, the upper limit of the volume resistivity at 25° C. of the material having the PTC property is preferably 30 Ω·cm or less, and more preferably 18 Ω·cm or less, and even more preferably 16 Ω·cm or less. As used herein, the volume resistivity at 25° C. of the material having the PTC property is measured according to JIS K 6271:2008.

From the viewpoints of creating a device that can be heated by electric conduction and have the PTC property, the outer peripheral wall 23 and the partition walls 26 are preferably made of a material containing barium titanate (BaTiO₃) as a main component. Also, this material is more preferably ceramics made of a material containing barium titanate (BaTiO₃)-based crystals as a main component in which a part of Ba is substituted with a rare earth element. As used herein, the term “main component” means a component in which a proportion of the component is more than 50% by mass of the total component. The content of BaTiO₃-based crystalline particles can be determined by fluorescent X-ray analysis. Other crystalline particles can be measured in the same manner as this method.

The compositional formula of BaTiO₃-based crystalline particles, in which a part of Ba is substituted with the rare earth element, can be expressed as (Ba₁₋ₓAₓ)TiO₃. In the compositional formula, the symbol A represents at least one rare earth element, and 0.001≤x≤0.010.

The symbol A is not particularly limited as long as it is the rare earth element, but it may preferably be one or more selected from the group consisting of La, Ce, Pr, Nd, Eu, Gd, Dy, Ho, Er, Y and Yb, and more preferably La. The x value is preferably 0.001 or more, and more preferably 0.0015 or more, in terms of suppressing excessively high electrical resistance at room temperature. On the other hand, x is preferably 0.009 or less, in terms of preventing the electrical resistance at room temperature from becoming too high due to insufficient sintering. The content of the BaTiO₃-based crystalline particles in which a part of Ba is substituted with the rare earth element in the ceramics is not particularly limited as long as it is determined to be the main component. However, it may preferably be 90% by mass or more, and more preferably 92% by mass or more, and even more preferably 94% by mass or more. The upper limit of the content of the BaTiO₃-based crystalline particles is not particularly limited, but it may generally be 99% by mass, and preferably 98% by mass.

In terms of reduction of the environmental load, it is desirable that the materials used for the outer peripheral wall 23 and the partition walls 26 are substantially free of lead (Pb). Specifically, the outer peripheral wall 23 and the partition walls 26 preferably have a Pb content of 0.01% by mass or less, and more preferably 0.001% by mass or less, and still more preferably 0% by mass. The lower Pb content can allow the air heated by contact with the heat-generating partition walls 26 to be safely applied to organisms such as humans, for example. In the outer peripheral wall 23 and the partition walls 26, the Pb content is preferably less than 0.03% by mass, more preferably less than 0.01% by mass, and even more preferably 0% by mass, as converted to PbO. The lead content can be determined by ICP-MS (inductively coupled plasma mass spectrometry).

The Curie point of the material making up the outer peripheral wall 23 and the partition walls 26 is preferably in a temperature range where the resistance value is twice or more the resistance at room temperature (25° C.). If the Curie point is in such a temperature range, the current flowing through the humidity controlling device 20 will be limited when the temperature of the humidity controlling device 20 becomes high, so that any excessive heat generation of the humidity controlling device 30 will be efficiently suppressed. Therefore, thermal deterioration of the moisture absorbing layer 27 caused by excessive heat generation can be suppressed.

The material making up the outer peripheral wall 23 and the partition walls 26 preferably have a lower limit of a Curie point of 80° C. or more, and more preferably 100° C. or more, and even more preferably 110° C. or more, and still more preferably 125° C. or more, in terms of efficiently heating the moisture absorbing layer 27. Further, in terms of safety as a component placed in the vehicle interior or near the vehicle interior, the upper limit of the Curie point is preferably 200° C. or more, more preferably 190° C. or more, even more preferably 180° C. or more, and still more preferably 150° C. or more.

The Curie point of the material making up the outer peripheral wall 23 and the partition walls 26 can be adjusted by the type and amount of shifter added. For example, the Curie point of barium titanate (BaTIO₃) is about 120° C., but the Curie point can be shifted to the lower temperature side by substituting a part of Ba and Ti with one or more of Sr, Sn and Zr.

As used herein, the Curie point is measured by the following method. A sample is attached to a sample holder for measurement, mounted in a measuring tank (e.g., MINI-SUBZERO MC-810P, from ESPEC). A change in electrical resistance of the sample as a function of a temperature when the temperature is increased from 10° C. is measured using a DC resistance meter (e.g., Multimeter 3478A, from JAPAN HEWLETT PACKARD, LLC). Based on an electrical resistance-temperature plot obtained by the measurement, a temperature at which the resistance value is twice the resistance value at room temperature (25° C.) is defined as the Curie point.

### (2-2. Pair of Electrodes 28a, 28b)

A pair of electrodes 28a, 28b may be provided on the first end face 24a and the second end face 24b as shown in FIG. 2A, although the positions of the electrodes 28a, 28b are not limited thereto. Also, the pair of electrodes 28a, 28b may be provided on a pair of outer peripheral walls 23 parallel to the extending direction of the cells 25.

Applying of a voltage between the pair of electrodes 28a, 28b allows the honeycomb structure 21 to generate heat by Joule heat.

The pair of electrodes 28a, 28b may employ, for example, a metal or alloy containing at least one selected from Cu, Ag, Al, Ni and Si, although not particularly limited thereto. It is also possible to use an ohmic electrode capable of ohmic contact with the outer peripheral wall 23 and/or the partition walls 26 which have the PTC property. The ohmic electrode may employ an ohmic electrode containing, for example, at least one selected from Al, Au, Ag and In as a base metal, and containing at least one selected from Ni, Si, Zn, Ge, Sn, Se and Te for n-type semiconductors as a dopant. Further, the pair of electrodes 28a, 28b may have a single-layer structure, or may have a laminated structure of two or more layers. When the pair of electrodes 28a, 28b have the laminated structure of two or more layers, the materials of the respective layers may be of the same type or of different types.

The thickness of the pair of electrodes 28a, 28b may be appropriately set according to the method for forming the pair of electrodes 28a, 28b. The method for forming the pair of electrodes 28a, 28b includes metal deposition methods such as sputtering, vapor deposition, electrolytic deposition, and chemical deposition. Alternatively, the pair of electrodes 28a, 28b can be formed by applying an electrode paste and then baking it, or by thermal spraying. Furthermore, the pair of electrodes 28a, 28b may be formed by joining metal sheets or alloy sheets.

Each of the thicknesses of the pair of electrodes 28a, 28b is, for example, about 5 to 80 μm for baking the electrode paste, and about 100 to 1000 nm for dry plating such as sputtering and vapor deposition, and about 10 to 100 μm for thermal spraying, and about 5 μm to 30 μm for wet plating such as electrolytic deposition and chemical deposition. Further, when joining the metal sheet or alloy sheet, each thickness is preferably about 5 to 100 μm.

### (3-3. Terminal 29)

The terminals 29 are connected to the pair of electrodes 28a, 28b, and provided on at least part of the pair of electrodes 28a, 28b. The provision of the terminals 29 facilitates connection to an external power supply. The terminals 29 are connected to a conductor connected to the external power supply.

The terminals 29 may be made of any material, including, but not particularly limited to, a metal, for example. The metal that can be used herein may include single metals, alloys, and the like, but from the viewpoint of corrosion resistance, electrical resistivity, and coefficient of linear expansion, it may preferably be alloys containing at least one selected from the group consisting of Cr, Fe, Co, Ni, Cu, Al, and Ti, and more preferably stainless steel, Fe—Ni alloy, and phosphor bronze.

The size and shape of the terminal 29 are not particularly limited. For example, as shown in FIG. 2A, the terminals 29 can be provided on the whole of the pair of electrodes 28a, 28b on the outer peripheral wall 23. Further, the terminals 29 may be provided on a part of the pair of electrodes 28a, 28b on the outer peripheral wall 23, or may be provided so as to extend toward an outer side than the outer edge of each of the pair of electrodes 28a, 28b on the outer peripheral wall 23. Further, the terminals 29 may be provided on a part of the pair of electrodes 28a, 28b on the partition walls 26, or may be provided so as to block a part of the cells 25.

Furthermore, the thickness of the terminal 29 is not particularly limited, but it is, for example, 0.01 to 10 mm, typically 0.05 to 5 mm.

The method of connecting the terminals 29 to the pair of electrodes 28a, 28b is not particularly limited as long as they are electrically connected. For example, they can be connected by diffusion bonding, a mechanical pressing mechanism, welding, or the like.

### (2-4. Moisture Absorbing Layer 27)

The moisture absorbing layer 27 is a layer having a function of adsorbing moisture (water vapor).

The moisture absorbing layer 27 can be provided on the surfaces of the partition walls 26 (in the case of the outermost cells 25, the partition walls 26 that define the outermost cells 25 and the outer peripheral wall 23). By thus providing the moisture absorbing layer 27, the moisture is easily adsorbed during the moisture absorption process, and the moisture absorbing layer 27 can be easily heated during the regeneration process, so that the moisture adsorbing function by the moisture absorbing layer 27 can be regenerated.

The moisture absorbing material contained in the moisture absorbing layer 27 preferably has a function that can adsorb the moisture at −20 to 40° C. and separate it at an elevated temperature of 60° C. or more.

Examples of the moisture absorbing material include, but not limited to, aluminosilicate, silica gel, silica, graphene oxide, polymer adsorbents, polystyrene sulfonic acid, and metal organic frameworks (MOFs). These may be used alone or in combination of two or more.

Examples of the aluminosilicate that can be preferably used herein include AFI type-, CHA type-, or BEA type-zeolite; porous clay minerals such as allophane and imogolite. Also, it is more preferable that the aluminosilicate is amorphous.

As the silica gel, type A silica gel is preferably used.

Examples of the polymer adsorbent that can be preferably used herein include a polymer adsorbent having a polyacrylic acid polymer chain. For example, sodium polyacrylate or the like can be used as the polymer adsorbent.

The metal organic framework is a crystalline hybrid material containing metal ions and organic molecules (organic ligands). The metal ions are preferably hydrophilic metal ions (for example, aluminum ions).

The moisture absorbing layer 27 is preferably capable of adsorbing carbon dioxide and/or volatile components in addition to moisture. Specifically, the moisture absorbing layer 27 can contain an adsorbent that can adsorb carbon dioxide and/or volatile components, in addition to the moisture absorbing material that can adsorb the moisture. If the moisture adsorbing material that can adsorb the moisture is also capable of adsorbing carbon dioxide and/or volatile components, the carbon dioxide and/or volatile components can be adsorbed in addition to the moisture by including only the moisture adsorbing material. By containing such a adsorbent or using the moisture absorbing material, it is possible to obtain an effect of purifying the air in addition to the effect of dehumidifying the air.

The adsorbent preferably has a function that can adsorb carbon dioxide and/or volatile components at −20 to 40° C. and separate them at an elevated temperature of 60° C. or more.

Examples of the adsorbent having such a function include zeolite, silica gel, activated carbon, alumina, silica, low-crystalline clay, amorphous aluminum silicate complexes, and the like. The type of the adsorbent may be appropriately selected depending on the types of the components to be removed. The adsorbent may be used alone, or in combination with two or more types.

The volatile components in the air in the vehicle interior are, for example, volatile organic compounds (VOCs) and odor components other than the VOCs. Specific examples of the volatile components include ammonia, acetic acid, isovaleric acid, nonenal, formaldehyde, toluene, xylene, paradichlorobenzene, ethylbenzene, styrene, chlorpyrifos, di-n-butyl phthalate, tetradecane, and di-2-ethylhexyl phthalate, diazinon, acetaldehyde, 2-(1-methylpropyl)phenyl N-methylcarbamate, and the like.

The moisture absorbing layer 27 can contain a catalyst. By containing the catalyst, it is possible to promote oxidation-reduction reaction and the like to purify carbon dioxide and/or volatile components. The catalyst having such a function includes metal catalysts such as Pt, Pd and Ag, and oxide catalysts such as CeO₂ and ZrO₂. The catalyst may be used alone or in combination of two or more types. The catalyst may also be used in combination with the functional material as described above.

The thickness of the moisture absorbing layer 27 may be determined according to the size of the cells 25, and is not particularly limited. For example, the thickness of the moisture absorbing layer 27 is preferably 20 μm or more, and more preferably 25 μm or more, and even more preferably 30 μm or more, from the viewpoint of ensuring sufficient contact with air. On the other hand, the thickness of the moisture absorbing layer 27 is preferably 400 μm or less, and more preferably 380 μm or less, and even more preferably 350 μm or less, from the viewpoint of suppressing separation of the moisture absorbing layer 27 from the partition walls 26 and the outer peripheral wall 23.

The thickness of the moisture absorbing layer 27 is measured using the following procedure. Any cross section of the honeycomb structure 21 parallel to the flow path direction is cut out, and a cross-sectional image at magnifications of about 50 is acquired using a scanning electron microscope or the like. Also, this cross section is made to pass through the center of gravity position in the cross section orthogonal to the flow path of the honeycomb structure 21. The thickness of each moisture absorbing layer 27 visually recognized from the cross-sectional image is calculated by dividing the cross-sectional area by the length of the cells 25 in the flow path direction. This calculation is performed for all the moisture absorbing layers 27 visually recognized from the cross-sectional image, and an average value thereof is determined to be the thickness of the moisture absorbing layer 27.

From the viewpoint of exerting a desired function in the humidity controlling device 20, an amount of the moisture absorbing layer 27 is preferably 50 to 500 g/L, and more preferably 100 to 400 g/L, and even more preferably 150 to 350 g/L, based on the volume of the honeycomb structure 21. It should be noted that the volume of the honeycomb structure 21 is a value determined by the external dimensions of the honeycomb structure 21.

### (2-5. Method for Producing Humidity Controlling Device 20)

The method for producing the humidity controlling device 20 according to the embodiment of the disclosure is not particularly limited, and it can be performed according to a known method. Hereinafter, the method for producing the humidity controlling device 20 according to an embodiment of the disclosure will be illustratively described.

A method for producing the honeycomb structure 21 forming the humidity controlling device 20 includes a forming step and a firing step.

In the forming step, a green body containing a ceramic raw material including BaCO₃ powder, TiO₂ powder, and rare earth nitrate or hydroxide powder is formed to prepare a honeycomb formed body having a relative density of 60% or more.

The ceramic raw material can be obtained by dry-mixing the powders so as to have a desired composition.

The green body can be obtained by adding a dispersion medium, a binder, a plasticizer and a dispersant to the ceramic raw material and kneading them together. The green body may optionally contain additives such as shifters, metal oxides, property improving agents, and conductor powder.

The blending amount of the components other than the ceramic raw material is not particularly limited as long as the relative density of the honeycomb formed body is 60% or more.

As used herein, the “relative density of the honeycomb formed body” means a ratio of the density of the honeycomb formed body to the true density of the entire ceramic raw material. More particularly, the relative density can be determined by the following equation:

relative density of honeycomb formed body (%)=density of honeycomb formed body (g/cm³)/true density of entire ceramic raw material (g/cm³)×100.

The density of the honeycomb formed body can be measured by the Archimedes method using pure water as a medium. Further, the true density of the entire ceramic raw material can be obtained by dividing the total mass of the respective raw materials (g) by the total of the actual volumes of the respective raw materials (cm³).

Examples of the dispersion medium include water or a mixed solvent of water and an organic solvent such as alcohol, and more preferably water.

Examples of the binder include organic binders such as methyl cellulose, hydroxypropoxyl cellulose, hydroxyethyl cellulose, carboxymethyl cellulose, and polyvinyl alcohol. In particular, it is preferable to use methyl cellulose in combination with hydroxypropoxyl cellulose. The binder may be used alone, or in combination of two or more, but it is preferable that the binder does not contain an alkali metal element.

Examples of the plasticizer include polyoxyalkylene alkyl ethers, polycarboxylic acid-based polymers, and alkyl phosphate esters.

The dispersant that can be used herein includes surfactants such as polyoxyalkylene alkyl ether, ethylene glycol, dextrin, fatty acid soaps, and polyalcohol. The dispersant may be used alone or in combination of two or more.

The honeycomb formed body can be produced by extruding the green body. For the extrusion, a die having a desired overall shape, cell shape, partition wall thickness, cell density and the like can be used.

The relative density of the honeycomb formed body obtained by extrusion is 60% or more, and preferably 65% or more. By limiting the relative density of the honeycomb formed body to such a range, the honeycomb formed body can be densified and the electrical resistance at room temperature can be reduced. The upper limit of the relative density of the honeycomb formed body is not particularly limited, but it may generally be 80%, and preferably 75%.

The honeycomb formed body can be dried before the firing step. Non-limiting examples of the drying method include known drying methods such as hot air drying, microwave drying, dielectric drying, drying under reduced pressure, drying in vacuum, and freeze drying. Among these, a drying method that combines the hot air drying with the microwave drying or dielectric drying is preferable because the entire formed body can be rapidly and uniformly dried.

The firing step includes maintaining the formed body at a temperature of from 1150 to 1250° C., and then increasing the temperature to a maximum temperature of from 1360 to 1430° C. at a heating rate of 20 to 600° C./hour, and maintaining the temperature for 0.5 to 10 hours.

The maintaining of the honeycomb formed body at the maximum temperature of from 1360 to 1430° C. for 0.5 to 10 hours can provide the honeycomb structure 21 containing, as a main component, BaTiO₃-based crystal particles in which a part of Ba is substituted with the rare earth element.

Further, maintaining the temperature of the honeycomb formed body of 1150 to 1250° C. can allow the Ba₂TiO₄ crystal particles generated in the firing process to be easily removed, so that the honeycomb structure 21 can be densified.

Further, the heating rate of 20 to 600° C./hour from the temperature of 1150 to 1250° C. to the maximum temperature of 1360 to 1430° C. can allow 1.0 to 10.0% by mass of Ba₆Ti₁₇O₄₀ crystal particles to be formed in the honeycomb structure 21.

The amount of time when the honeycomb formed body is maintained at 1150 to 1250° C. is not particularly limited, but it may preferably be from 0.5 to 10 hours. Such a maintaining time can lead to stable and easy removal of Ba₂TiO₄ crystal particles generated in the firing process.

The firing step preferably includes maintaining the honeycomb formed body at 900 to 950° C. for 0.5 to 5 hours while the temperature is increased. Maintaining the honeycomb formed body at 900 to 950° C. for 0.5 to 5 hours can lead to sufficient decomposition of BaCO₃, so that a honeycomb structure 21 having a predetermined composition can be easily obtained.

Prior to the firing step, a degreasing step for removing the binder may be performed. The degreasing step may preferably be performed in an air atmosphere in order to decompose the organic components completely.

Also, the atmosphere of the firing step may preferably be the air atmosphere in terms of control of electrical characteristics and production cost.

A firing furnace used in the firing step and the degreasing step is not particularly limited, but it may be an electric furnace, a gas furnace, or the like.

The pair of electrodes 28a, 28b is formed on the honeycomb structure 21 thus obtained. The pair of electrodes 28a, 28b can be formed by metal deposition methods such as sputtering, vapor deposition, electrolytic deposition, and chemical deposition. Further, the pair of electrodes 28a, 28b can also be formed by applying an electrode paste and then baking it. Furthermore, the pair of electrodes 28a, 28b can also be formed by thermal spraying. The pair of electrodes 28a, 28b may be composed of a single layer, but may also be composed of a plurality of electrode layers having different compositions. A typical method for forming the pair of electrodes 28a, 28b will be described below.

First, an electrode slurry containing an electrode material, an organic binder, and a dispersion medium is prepared, and the first end face 24a or the second end face 24b of the honeycomb structure 21 is coated with the slurry. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. An excess slurry on the periphery of the honeycomb structure 21 is removed by blowing and wiping. The slurry can be then dried to form the pair of electrodes 28a, 28b on the first end face 24a or the second end face 24b of the honeycomb structure 21. The drying can be performed while heating the honeycomb structure 21 to a temperature of about 120 to 600° C., for example. Although a series of steps of coating, slurry removal, and drying may be performed only once, the steps can be repeated multiple times to provide the pair of electrodes 28a, 28b having desired thicknesses.

The terminals 29 are then disposed at predetermined positions of the pair of electrodes 28a, 28b, and the pair of electrodes 28a, 28b and the terminals 29 are connected to each other. As a method for connecting the pair of electrodes 28a, 28b to the terminals 29, the method described above can be used.

It should be noted that the terminals 29 may be disposed after forming a moisture absorbing layer 27 described below.

The moisture absorbing layer 27 is then formed on the surfaces of the partition walls 26 and the like of the honeycomb structure 21.

Although the method for forming the moisture absorbing layer 27 is not particularly limited, it can be formed, for example, by the following steps. The honeycomb structure 21 is immersed in a slurry containing a moisture absorbent, an organic binder, and a dispersion medium for a predetermined period of time, and an excess slurry on the end faces and the outer periphery of the honeycomb structure 21 is removed by blowing and wiping. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. The slurry can be then dried to form the moisture absorbing layer 27 on the surfaces of the partition walls 26. The drying can be performed while heating the honeycomb structure 21 to a temperature of about 120 to 600° C., for example. Although a series of steps of immersion, slurry removal, and drying may be performed only once, the steps can be repeated multiple times to provide the moisture absorbing layer 27 having the desired thickness on the surfaces of the partition walls 26 and the like.

### (3. Power Source 40)

The power source 40 is for applying a voltage to the humidity controlling device 20 (in particular, the pair of electrodes 28a, 28b). The power source 40 is electrically connected to the control unit 30, and adjusts the state of the voltage applied to the pair of electrodes 28a, 28b according to instructions from the control unit 30.

The power source 40 is not particularly limited, and a battery or the like can be used.

### (4. Ventilation Fan 60)

The ventilation fan 60 is a device for allowing the air from the vehicle interior or the vehicle exterior to flow in the humidity controlling device 20, and is provided in the air conditioning duct 10. The position of the ventilation fan 60 is not limited, but it may be on the upstream side of the humidity controlling device 20, for example, as illustrated in FIG. 1, or on the downstream side of the humidity controlling device 20.

The ventilation fan 60 is electrically connected to the control unit 30 and can control the flow velocity of the air by adjusting the rotation speed according to instructions from the control unit 30.

### (5. Control Unit 30)

Also, the control unit 30 is electrically connected to the power source 40, the valve 50, the ventilation fan 60, and the like, and it can control these members. The control unit 30 can control the power source 40, thereby adjusting the heating state of the honeycomb structure 21 by controlling a voltage applying state to the pair of electrodes 28a, 28b of the humidity controlling device 20. Further, the control unit 30 can also control the valve 50 so that the air flows through the first flow path 10a or the second flow path 10b. Furthermore, the control unit 30 can adjust the rotation speed of the ventilation fan 60, thereby controlling the flow velocity of the air flowing through the air conditioning duct 10.

The control unit 30 is generally an ECU (Engine (electronic) Control Unit), although not particularly limited thereto. The ECU is a CPU for executing various calculation processes, a ROM for storing programs and data required for its control, a RAM for temporarily storing results of calculations performed by the CPU, and input/output ports for inputting and outputting signals to and from the outside.

In the moisture absorption process of the humidity controlling device 20, the control unit 30 includes turning off the applied voltage from the power source 40 and switching the valve 50 so that the air flowing through the air conditioning duct 10 passes through the first flow path 10a (i.e., a moisture absorption mode), and turning on the applied voltage from the power source 40 and switching the valve 50 so that the air flowing through the air conditioning duct 10 passes through the second flow path 10b (i.e., a regeneration mode). By performing the moisture absorption mode and the regeneration mode in such a manner, the moisture absorption process and the regeneration process can be efficiently carried out.

In the case of the moisture absorption mode, the moisture in the air flowing from the vehicle interior or the vehicle exterior are absorbed by the above control in the control unit 30. At this time, the honeycomb structure 21 of the humidity controlling device 20 is not heated. Specifically, the air from the vehicle interior or the vehicle exterior flows in the humidity controlling device 20 through the air conditioning duct 10, and the moisture contained in the air are trapped (adsorbed). The air that has trapped the moisture is returned to the vehicle interior through the first flow path 10a.

In the case of the regeneration mode, the moisture absorbing layer 27 of the humidity controlling device 20 is regenerated by the above control in the control unit 30. At this time, the honeycomb structure 21 of the humidity controlling device 20 is heated. Specifically, the air from the vehicle interior or vehicle exterior allows the moisture trapped in the moisture absorbing layer 27 to be separated while the air flows in the humidity controlling device 20 through the air conditioning duct 10 and passes through the humidity controlling device 20. Then, the air containing the moisture is discharged to the vehicle exterior through the second path 10b.

In the regeneration mode, the moisture absorbing layer 27 is preferably heated at a temperature higher than the separating temperature depending on the type of the moisture absorbing material in order to promote the separation of the moisture trapped by the moisture absorbing layer 27. For example, it is more preferable to heat the moisture absorbing layer 27 at 70 to 150° C., even more preferably 80 to 140° C., and still more preferably 90 to 130° C.

From the viewpoint of stably performing the above control, it is desirable that the humidity controlling device 20 be placed at a position close to the vehicle interior. Therefore, from the viewpoint of preventing electric shock and the like, it is preferable that the driving voltage of the humidity controlling device 20 is 60V or less. Since the honeycomb structure 21 used in the humidity controlling device 20 has a low electrical resistance at room temperature, the honeycomb structure 21 can be heated at the low driving voltage. It should be noted that the lower limit of the driving voltage is not particularly limited, but it may preferably be 10 V or more. If the driving voltage is less than 10V, the current during heating the honeycomb structure 21 becomes large, so that the conductor wire should be thick.

### <Method for Using Humidity Controlling Device>

In the above humidity controlling device 20 placed in the air conditioning duct 10, the method for using the humidity controlling device according to an embodiment includes controlling the flow velocity of the air flowing in the humidity controlling device 20 to 0.23 to 1.40 m/s, preferably 0.24 to 1.30 m/s, more preferably 0.25 to 1.20 m/s, and even more preferably 0.26 to 1.10 m/s, during the moisture absorption process of the humidity controlling device 20. With such control of the flow velocity, the moisture can be efficiently adsorbed in the moisture absorbing layer 27 of the humidity controlling device 20 while feeding dry air that is difficult to fog up windows for a long period of time. On the other hand, if the flow velocity of the air is less than 0.23 m/s, the amount of moisture adsorbed decreases, so that the moisture absorption process of the humidity conditioning device 20 needs to be performed for a longer period of time, and it is also difficult to feed the dry air that is difficult to fog up the windows. If the flow velocity of the air exceeds 1.40 m/s, the amount of moisture adsorbed becomes excessive and is early saturates, so that the time to feed the dry air that is difficult to fog up the windows will be shortened. Furthermore, the size of the ventilation fan 60 needs to be increased in order to increase the flow velocity of the air, or the noise level increases due to the increased rotation speed of the ventilation fan 60, or the requirements for the surrounding components such as the air conditioning duct 10 become more demanding due to the increased pressure loss.

The duration time for the moisture absorption process of the humidity controlling device 20 is not particularly limited, but it may preferably be 0.16 to 6 minutes, more preferably 0.33 to 5 minutes, and even more preferably 0.5 to 4 minutes. By limiting the duration time for the moisture adsorption process to that range, it is easier to ensure the amount of moisture adsorbed while limiting the waste of the moisture adsorption process due to the saturation of the amount of the moisture adsorbed. On the other hand, if the moisture absorption process of the humidity controlling device 20 is for less than 0.16 minutes, it is difficult to ensure the amount of the moisture adsorbed. If the duration time for the moisture absorption process of the humidity controlling device 20 exceeds 6 minutes, the amount of the moisture adsorbed is easily saturated.

The regeneration process of the humidity controlling device 20 preferably includes controlling the flow velocity of the air flowing in the humidity controlling device 20 to 0.06 to 0.30 m/s. According to such control of the flow velocity, it is possible to separate the moisture adsorbed in the moisture absorbing layer 27 of the humidity controlling device efficiently. From the viewpoint of stably ensuring these effects, it is more preferable that it includes controlling the flow velocity of the air to 0.08 to 0.20 m/s. On the other hand, if the flow velocity of the air exceeds 0.30 m/s, the humidity controlling device 20 is easily cooled by the circulating air, making it difficult for the moisture to be separated from the moisture absorbing layer 27. If the flow velocity of the air is less than 0.06 m/s, the contact with the circulating air decreases, so that the moisture is difficult to be separated from the moisture absorbing layer 27.

The duration time for the regeneration process of the humidity controlling device 20 is not particularly limited, but it may preferably be 0.16 to 4 minutes, more preferably 0.33 to 4 minutes, and even more preferably 0.5 to 3 minutes. By limiting the duration time for the regeneration process to that range, it is easier to ensure the amount of the moisture separated while limiting the waste of the regeneration process due to the saturation of the amount of the moisture separated. On the other hand, if the regeneration process of the humidity controlling device 20 is less than 0.16 minutes, it is difficult to ensure the amount of the moisture separated. If the regeneration process of the humidity controlling device 20 exceeds 4 minutes, the amount of the moisture separated is easily saturated.

The humidity controlling device 20 used for the method for using the humidity controlling device according to an embodiment is described above, and detailed descriptions thereof are omitted.

### EXAMPLES

Hereinafter, the disclosure will be more specifically described with reference to Examples, but the disclosure is not limited to these Examples.

### <Production of Humidity Controlling Device>

As ceramic raw materials were prepared BaCO₃ powder, TiO₂ powder, and La(NH₃)₃·6H₂O powder. These powders were weighed to have the required composition after firing, and dry-mixed to obtain a mixed powder. The dry mixing was performed for 30 minutes. To 100 parts by mass of the resulting mixed powder were then added water, a binder, a plasticizer, and a dispersant by an appropriate amount in the range of 3 to 30 parts by mass in total so as to obtain a ceramic formed body having a relative density of 64.8% after extrusion, and then kneaded to obtain a green body. Methylcellulose was used as the binder. Polyoxyalkylene alkyl ethers were used as the plasticizer and the dispersant.

The resulting green body was then fed into an extrusion molding machine and extruded using a predetermined die to form a honeycomb structure having the shape illustrated below after firing.
Shape of cross section and end face of honeycomb structure orthogonal to flow path direction: quadrangular;
Shape of cross section of cells orthogonal to flow path direction: quadrangular;
Thickness of partition wall: 0.1 mm;
Thickness of outer peripheral wall: 0.2 mm;
Cell density: 80 cells/cm²;
Cell pitch: 1.1 mm;
Cross-sectional area of honeycomb structure orthogonal to flow path direction: 6000 mm²;
Length of honeycomb structure in flow path direction: 10 mm;
Volume resistivity of materials comprised of outer peripheral wall and partition wall at 25° C.: 15 Ω·cm; and
Curie point of material making up outer peripheral wall and partition wall: 110° C.

Subsequently, the resulting honeycomb structure was subjected to dielectric drying and hot air drying, and then degreased (450° C. for 4 hours) in a sintering furnace in an air atmosphere, and then sintered in an air atmosphere. The firing was performed by maintaining the honeycomb structure at a temperature of 950° C. for 1 hour, then increasing the temperature to 1200° C. and maintaining it at 1200° C. for 1 hour, and then increasing the temperature to 1400° C. (maximum temperature) at a rate of 200° C./hour and maintaining it at a temperature of 1400° C. for 2 hours.

The pair of electrodes were formed on both end faces (first end face and second end face) of the resulting honeycomb structure. First, an electrode slurry containing aluminum (electrode material), ethyl cellulose and diethylene glycol monobutyl ether (organic binder) was prepared and applied to the first end face, and the electrode slurry was then dried to form an electrode on the first end face. Using the same electrode slurry, an electrode was formed on the second end face by applying the electrode slurry to the second end face and drying it.

The honeycomb structure with a pair of electrodes was then immersed in a slurry containing zeolite (moisture absorbing material), an organic binder, and water, and the slurry adhering to excess positions (such as the periphery) was removed by blowing and wiping, and then dried at about 550° C. to form a moisture absorbing layer having a thickness of 150 μm on surfaces of the partition walls and on a surface of the outer peripheral wall facing the cells.

The humidity controlling device obtained as described above was placed in the air conditioning duct to construct the vehicle air conditioning system illustrated in FIG. 1. The following evaluations were performed on the vehicle air conditioning system.

### <Moisture Absorption Performance 1 (Moisture Absorption Rate)

The vehicle air conditioning system was subjected to the regeneration mode, followed by the moisture absorption mode. The regeneration mode was performed by starting the ventilation fan and allowing the air at a temperature of 25° C. and at relative humidity of 40% to flow at a flow velocity of 0.07 m/s into the air conditioning duct while applying a voltage of 12 V from a direct current power source to the humidity controlling device for 4 minutes. The moisture absorption mode was performed by allowing the air under the same conditions to flow in the air conditioning duct for 5 minutes at each flow velocity illustrated in Table 1, without applying a voltage to the humidity controlling device.

In the regeneration mode, the absolute humidity [g/m³] at the inlet and outlet of the humidity controlling device was measured by humidity sensors, and an amount of moisture released [g] was calculated by the following equation:

Amount of moisture released [g]=(absolute humidity at outlet of humidity controlling device [g/m³]-absolute humidity at inlet of humidity controlling device [g/m³])×flow rate [m³/min]×duration time for regeneration mode [min]

In the moisture absorption mode, the absolute humidity [g/m³] at the inlet and outlet of the humidity controlling device was measured by humidity sensors, and an amount of moisture absorbed [g] was calculated by the following equation:

Amount of moisture absorbed [g]=(absolute humidity at inlet of humidity controlling device [g/m³]−absolute humidity at outlet of humidity controlling device [g/m³])×flow rate [m³/min]×duration time for adsorption mode [min].

The moisture absorption rate [%] for the moisture absorption mode was then calculated by dividing the amount of moisture absorbed [g] by the amount of moisture released [g] and multiplying the resulting numerical value by 100. The results are summarized in Table 1.

TABLE 1

| | | Moisture | |
|---|---|---|---|
| | Flow Velocity | Absorption | |
| Nos. | of Air (m/s) | Rate (%) | Classification |
| 1 | 0.14 | 41 | Comp. |
| 2 | 0.20 | 78 | Comp. |
| 3 | 0.25 | 87 | Example |
| 4 | 0.55 | 99 | Example |
| 5 | 0.07 | 10 | Comp. |

As illustrated in Table 1, Nos. 1-3 and 1-4 (Examples) in which the flow velocity of the air flowing in the humidity controlling device was controlled to 0.23 to 1.40 m/s in the moisture absorption process (humidity absorption mode) of the humidity controlling device had higher moisture absorption rates than Nos. 1-1, 1-2, and 1-5 (Comparative Examples) in which the flow velocity of the air was controlled outside the above range.

### <Moisture Absorption Performance 2 (Effective Moisture Absorption Rate)

The vehicle air conditioning system was subjected to the regeneration mode, followed by the moisture absorption mode. The regeneration mode was performed by starting the ventilation fan and allowing the air at a temperature of 25° C. and at relative humidity of 40% to flow at a flow velocity of 0.07 m/s into the air conditioning duct while applying a voltage of 12 V from a direct current power source to the humidity controlling device for 4 minutes. The moisture absorption mode was performed by allowing the air at a temperature of 25° C. and at absolute humidity of 8 g/m³ to flow in the air conditioning duct for 4 minutes at each flow velocity illustrated in Table 2.

In the moisture absorption mode, the absolute humidity at the outlet of the humidity controlling device was measured by a humidity sensor and the duration time during which the absolute humidity could be maintained at 4 g/m³ or less was measured. Then, a rate [%] of the duration time during which the absolute humidity could be maintained at 4 g/m³ or less relative to a time period for the moisture absorption mode (4 minutes) (hereinafter referred to as an “effective moisture absorption rate”) was calculated. The range of the absolute humidity of 4 g/m³ or less is the absolute humidity that is difficult to fog up windows, and if the effective moisture absorption rate is 30% or higher, it can be said that the dry air that is difficult to fog up the windows can be fed for a long period of time. The results are summarized in Table 2.

TABLE 2

| | Flow | Time during which | Effective | |
|---|---|---|---|---|
| | Velocity | Absolute Humidity | Moisture | |
| | of Air | could be Maintained | Absorption | |
| Nos. | (m/s) | at 4 g/m³ or less (s) | Rate (%) | Classification |
| 1 | 0.07 | 0 | 0 | Comp. |
| 2 | 0.14 | 0 | 0 | Comp. |
| 3 | 0.23 | 77 | 32 | Example |
| 4 | 0.24 | 103 | 43 | Example |
| 5 | 0.25 | 129 | 54 | Example |
| 6 | 0.26 | 155 | 65 | Example |
| 7 | 1.10 | 149 | 62 | Example |
| 8 | 1.20 | 123 | 51 | Example |
| 9 | 1.30 | 99 | 41 | Example |
| 10 | 1.40 | 76 | 32 | Example |
| 11 | 1.50 | 51 | 21 | Comp. |
| 12 | 2.00 | 43 | 18 | Comp. |

As illustrated in Table 2, Nos. 2-3 to 2-10 (Examples) in which the flow velocity of the air flowing in the humidity controlling device was controlled to 0.23 to 1.40 m/s in the moisture absorption process (humidity absorption mode) had an effective moisture absorption rate of 30% or higher, and the duration time during which the dry air that was difficult to fog up the windows could be fed was longer.

In contrast, Nos. 2-1 and 2-2 (Comparative Examples) in which the flow velocity of the air flowing in the humidity controlling device in the moisture absorption process (humidity absorption mode) was less than 0.23 m/s were unable to reduce the absolute humidity to 4 g/m³ or less and were unable to feed the dry air that was difficult to fog up the windows. Further, Nos. 2-11 and 2-12 (Comparative Examples) in which the flow velocity of the air flowing in the humidity controlling device in the moisture absorption process (humidity absorption mode) exceeded 1.40 m/s could reduce the absolute humidity to 4 g/m³ or less, but the amount of moisture adsorbed was early saturated and the effective moisture absorption rate was less than 30%, so that the duration time during which the dry air that was difficult to fog up the windows could be fed became shorter.

### <Regeneration Performance 1 (Moisture Release Rate)

The vehicle air conditioning system was subjected to the moisture absorption mode, followed by the regeneration mode. The moisture absorption mode was performed by starting the ventilation fan and allowing the air at a temperature of 25° C. and at relative humidity of 40% to flow at a flow rate of 1.10 m/s into the air conditioning duct for 3 minutes. The regeneration mode was performed by allowing the air under the same conditions to flow in the air conditioning duct for 6 minutes at each flow velocity illustrated in Table 3, while applying a voltage of 12 V from a direct current power source to the humidity controlling device.

In each of the regeneration mode and the moisture absorption mode, the absolute humidity [g/m³] at the inlet and outlet of the humidity controlling device was measured, and the amount of moisture absorbed [g] in the moisture absorption mode and the amount of moisture released [g] in the regeneration mode were calculated as described above. The moisture release rate [%] for the regeneration mode was then calculated by dividing the amount of moisture released [g] by the amount of moisture absorbed [g] and multiplying the resulting numerical value by 100. The results are summarized in Table 3.

TABLE 3

| | | Moisture | |
|---|---|---|---|
| | Flow Velocity of | Release Rate | |
| Nos. | Air (m/s) | (%) | Classification |
| 1 | 1.00 | 40 | Comp. |
| 2 | 0.70 | 65 | Comp. |
| 3 | 0.50 | 78 | Comp. |
| 4 | 0.28 | 99 | Example |
| 5 | 1.30 | 20 | Comp. |

As illustrated in Table 3, No. 3-4 (Example) in which the flow velocity of the air flowing in the humidity controlling device was controlled to 0.06 to 0.30 m/s in the regeneration process of the humidity controlling device (regeneration mode) had a higher moisture release rate than Nos. 3-1 to 3-3 and 3-5 (Comparative Examples) in which the flow velocity of the air was controlled outside the above range.

### <Regeneration Performance 2 (Moisture Release Rate)>

The test was conducted under the same conditions as those described above, with the exception that the time for the regeneration process was changed to 2 minutes, and the moisture release rate [%] in the regeneration mode was calculated. The results are summarized in Table 4.

TABLE 4

| | | Moisture | |
|---|---|---|---|
| | Flow Velocity | Release Rate | |
| Nos. | of Air (m/s) | (%) | Classification |
| 1 | 0.05 | 21 | Comp. |
| 2 | 0.06 | 53 | Example |
| 3 | 0.08 | 56 | Example |
| 4 | 0.20 | 60 | Example |
| 5 | 0.30 | 57 | Example |
| 6 | 0.50 | 36 | Comp. |
| 7 | 0.70 | 20 | Comp. |
| 8 | 1.00 | 12 | Comp. |
| 9 | 1.30 | 9 | Comp. |

As illustrated in Table 4, Nos. 4-2 to 4-5 (Examples) in which the flow velocity of the air flowing in the humidity controlling device was controlled to 0.06 to 0.30 m/s in the regeneration process of the humidity controlling device (regeneration mode) had higher moisture release rates than Nos. 4-1 and 4-6 to 4-9 (Comparison Examples) in which the flow velocity of the air was controlled outside the above range.

As can be seen from the above results, according to the invention, it is possible to provide a vehicle air conditioning system that can efficiently adsorb the moisture, and a method for using a humidity controlling device.

### DESCRIPTION OF REFERENCE NUMERALS

10 air conditioning duct
10a first flow path
10b second flow path
20 humidity controlling device
21 honeycomb structure
23 outer peripheral wall
24a first end face
24b second end face
25 cell
26 partition wall
27 moisture absorbing layer
28a, 28b pair of electrodes
29 terminal
30 control unit
40 power source
50 valve
60 ventilation fan
100 vehicle air conditioning system

1. A vehicle air conditioning system, comprising:
an air conditioning duct through which air can flow;
at least one humidity controlling device comprising: a honeycomb structure having an outer peripheral wall and partition walls provided on an inner side of the outer peripheral wall, the partition walls defining a plurality of cells, each of the cells extending from a first end face to a second end face of the honeycomb structure to form a flow path for the air; and a moisture absorbing layer provided on a surface of each of the partition walls, the humidity controlling device being provided in the air conditioning duct; and
a control unit configured to control a flow velocity of the air flowing through the cells of the humidity controlling device,
wherein the control unit comprises controlling the flow velocity of the air flowing in the humidity controlling device to 0.23 to 1.40 m/s in a moisture absorption process of the humidity controlling device.

2. The vehicle air conditioning system according to claim 1, wherein the control unit comprises controlling the flow velocity of the air flowing in the humidity controlling device to 0.24 to 1.30 m/s in the moisture absorption process of the humidity controlling device.

3. The vehicle air conditioning system according to claim 1, wherein the control unit comprises controlling the flow velocity of the air flowing in the humidity controlling device to 0.25 to 1.20 m/s in the moisture absorption process of the humidity controlling device.

4. The vehicle air conditioning system according to claim 1, wherein the control unit comprises controlling the flow velocity of the air flowing in the humidity controlling device to 0.26 to 1.10 m/s in the moisture absorption process of the humidity controlling device.

5. The vehicle air conditioning system according to claim 1, wherein the control unit comprises performing the moisture absorption process of the humidity controlling device for 0.16 to 6 minutes.

6. The vehicle air conditioning system according to claim 1, wherein the control unit comprises controlling the flow velocity of the air flowing in the humidity controlling device to 0.06 to 0.30 m/s in a regeneration process of the humidity controlling device.

7. The vehicle air conditioning system according to claim 6, wherein the control unit comprises controlling the flow velocity of the air flowing in the humidity controlling device to 0.08 to 0.20 m/s in the regeneration process of the humidity controlling device.

8. The vehicle air conditioning system according to claim 6, wherein the control unit comprises performing the regeneration process of the humidity controlling device for 0.16 to 4 minutes.

9. A method for using a humidity controlling device, the humidity controlling device comprising: a honeycomb structure having an outer peripheral wall and partition walls provided on an inner side of the outer peripheral wall, the partition walls defining a plurality of cells, each of the cells extending from a first end face to a second end face of the honeycomb structure to form a flow path for air; and a moisture absorbing layer formed on a surface of each of the partition walls, the humidity controlling device being provided in the air conditioning duct,
wherein the method comprises controlling a flow velocity of the air flowing in the humidity controlling device to 0.23 to 1.40 m/s during a moisture absorption process of the humidity controlling device.

10. The method for using the humidity controlling device according to claim 9, wherein the method comprises controlling the flow velocity of the air flowing in the humidity controlling device to 0.24 to 1.30 m/s during the moisture absorption process of the humidity controlling device.

11. The method for using the humidity controlling device according to claim 9, wherein the method comprises controlling the flow velocity of the air flowing in the humidity controlling device to 0.25 to 1.20 m/s during the moisture absorption process of the humidity controlling device.

12. The method for using the humidity controlling device according to claim 9, wherein the method comprises controlling the flow velocity of the air flowing in the humidity controlling device to 0.26 to 1.10 m/s during the moisture absorption process of the humidity controlling device.

13. The method for using the humidity controlling device according to claim 9, wherein the method comprises performing the moisture absorption process of the humidity controlling device for 0.16 to 6 minutes.

14. The method for using a humidity controlling device according to claim 9, wherein the method comprises controlling the flow velocity of the air flowing in the humidity controlling device to 0.06 to 0.30 m/s during a regeneration process of the humidity controlling device.

15. The method for using the humidity controlling device according to claim 14, wherein the method comprises controlling the flow velocity of the air flowing in the humidity controlling device to 0.08 to 0.20 m/s during the regeneration process of the humidity controlling device.

16. The method for using the humidity controlling device according to claim 14, wherein the method comprises performing the regeneration process of the humidity controlling device for 0.16 to 4 minutes.
